(19) United States
(12) Patent Application Publication
(10) Pub. No.: US 2026/0007147 A1
(43) Pub. Date: Jan. 8, 2026

(54) PRODUCTION METHOD FOR ANIMAL-DERIVED PROTEIN

(71) Applicant: SUZUHIRO KAMABOKO HONTEN CO., LTD., Odawara-shi, Kanagawa (JP)

(72) Inventors: Hiroaki SUZUKI, Odawara-shi (JP); Kanetomo JIN, Odawara-shi (JP); Jianrong WAN, Odawara-shi (JP); Tomohiro SUZUKI, Odawara-shi (JP)

(21) Appl. No.: 18/881,419

(22) PCT Filed: Jul. 8, 2022
(86) PCT No.: PCT/JP2022/027158

§ 371 Date: Jan. 6, 2025

(51) Int. Cl. A23J 1/04

(52) U.S. Cl. CPC A23J 1/04

(57) ABSTRACT

Provided is a production method for animal-derived protein with which fish protein separated and collected from bones can be efficiently produced.

A production method for animal-derived protein, including:
an enzyme addition step of finely cutting a raw material composed of at least one of fish and processing residue thereof and adding an enzyme solution;
a depressurization step of performing a depressurization/normal-pressurization operation once or more in which the raw material treated in the enzyme addition step is vacuum-depressurized, moisture in a raw material is vaporized, and then pressure is returned to normal pressure;
an enzymatic decomposition step of leaving the raw material for a certain period of time at an optimum temperature and an optimum pH for an enzyme reaction of the enzyme solution;
an enzyme deactivation step of raising a temperature to 90° C. to 95° C. to deactivate the enzyme in the enzyme solution at a high temperature; and
a bone and meat separation step of separating and collecting protein of the raw material from bones by a bone and meat separation device after deactivating the enzyme in the enzyme deactivation step.

### TECHNICAL FIELD

The present invention relates to a production method for animal-derived protein, particularly a production method for fish protein separated and collected from bones.

### Background Art

By A.D. 2050, it is predicted that the world will be facing a serious crisis of protein shortages and climate change. For this reason, the British medical journal “Lancet” dated January 16, A.D. 2019 published a paper proposing to increase the amount of blue foods (such as animals, plants, or algae derived from marine environments or fresh water environments) in order to support the diet for a world population reaching 10 billion people by A. D. 2050 (see, for example, Non Patent Literature 1). In addition, the EAT-Lancet Committee states that in order to provide healthy diets to the people of the world, which is said will reach about 10 billion people in A.D. 2050, and to achieve the “Sustainable Development Goals (SDGs)” and the “Paris Agreement”, conversion to healthy diets using a sustainable food system is necessary. In addition, in the journal Nature, dated September 15, A. D. 2021, a paper suggesting that increasing consumption of blue foods may improve the quality of diets was published (see, for example, Non Patent Literature 2).

The total production of marine products in the world in A.D. 2018 was 178.5 million tons, of which 156.4 million tons was used for human food and 22 million tons was used for fish meal and fish oils and for purposes other than human food. The marine products used for the purpose of human food are 45% fresh products, 31% frozen products, 12% salted and dried products, and 12% other processed products.

In A.D. 2018, marine fish catches of the world were 84.4 million tons, of which fish accounted for 71.93 million tons. South American anchovies (7 million tons), which have the first largest catch amount, European blue whitings (1.71 million tons), which had the fifth largest catch amount, and the like have small fish bodies, and thus most are used for fish meal, and walleye pollack (3.4 million tons), which had the second largest catch amount, is also mainly used as a raw material for fillets and minced fish, and a large amount of what is called “residue” such as heads, fins, skin, backbones, and scales is generated (see, for example, Non Patent Literature 3).

Fish residue and waste are generated during the series of distribution processes from fish landing to consumption. Specifically, the residue and waste are generated in three stages of a landing area stage, a processing area stage, and a consumption area stage. Regarding the generation at the landing area stage, there is residue generated in a primary treatment in a production area or a pre-processing step of processed small fish that were not taken bids, discarded fish having no market value, and the like. The processing residue generated at the processing area stage is residue generated from fillets, minced fish, canned foods, and the like, and a generated amount thereof is extremely large. In the generation of fish residue at the consumption area stage, the generated amount is large mainly in mass retailers, restaurants, food services, hotels and inns, and the like.

Skeletal muscles of fish are muscles attached to bones, skin, and other skeletal muscles, and have functions such as moving the skeleton such as a joint and the spinal column, maintaining a posture against gravity, generating energy by performing muscle contraction, and protecting internal organs. Skeletal muscles are composed of muscle fibers and interstitium, which is a connective tissue mainly composed of hard protein such as streaks and tendons. Examples of the hard protein include collagen and elastin.

For example, collagen is protein that mainly constitutes the skin, fascia, ligaments, tendons, bones, and the like of vertebrates, and is a main component of the extra cellular matrix (ECM) of animals. A total amount of collagen present in a body is as large as about ⅓ of the total protein in vertebrates such as fish.

The fact that these protein can be completely separated from bones has great significance, due to allowing the development of edible protein sources, eliminating food waste, reducing the amount of methane gas from livestock cultivation, achieving SDGs, and the like.

The marine processing industry has studied and utilized myosin, actin, and the like, which are components of fish meat fibrils. However, it is only a part of fish meat protein, and fish also contain many other protein.

In 1960, frozen minced fish, which is a raw material for producing various fish paste products including Kamaboko, was developed by a research group led by Kyosuke Nishitani of Hokkaido Central Fisheries Experimental Station at the time, and put the prevention of frozen denaturation of fish meat protein into practical use by exposing fillets of walleye pollack to water, and mixing saccharides and polymerized phosphates in dehydrated refined fish meat and freezing the mixture (see, for example, Non Patent Literature 4). This is an innovative technology for the marine processing industry, and frozen minced fish is currently mostly used to produce fish meat-derived paste products. Frozen minced fish is produced all over the world because it can be processed in large quantities and maintain fish prices, and “SURIMI” has become a universal language. Currently, 800,000 tons or more of frozen minced fish per year is produced in various countries of the world including the United States, China, Vietnam, India, and Thailand. In the frozen minced fish, since only refined fish meat is frozen, there are an advantage that it is convenient to store and transport raw materials at a stage before producing various paste products, an advantage that it is possible to omit steps that require manpower such as cooking and soaking of raw material fish in water, and an advantage that raw materials with stable quality can be stably obtained and stored throughout the year. However, depending on the fish species, a yield of the minced fish is as poor as 25% to 40%, and a large amount of processing residue is generated in a production step of the frozen minced fish.

In the fish paste product industry, fish meat collecting machines that physically separate fish meat from bones and skin have been developed since the 1920s, and include a stamp type, a mesh drum type (roll type), a caterpillar type, and the like, and all types have the same principle (see, for example, Patent Literature 1 and Patent Literature 2). Fish is crushed on a mesh plate or a drum having an infinite number of fine holes, and only soft meat is pushed out of the holes and separated from strong bones and skin. This collected fine fish meat is called “minced fish meat”.

For example, in a mesh drum type fish meat collecting machine, as illustrated in FIG. 5, a mesh drum 502 having a large number of holes and a rubber belt 503 are brought into contact with each other and rotated in opposite directions. Fish 501 is crushed between the mesh drum 502 and the rubber belt 503, and only fish meat 504 is fed into the mesh drum 502.

Such fish meat collecting machines currently use dressed fish from which heads and internal organs have been removed as separated raw materials, and even if these raw materials are harvested during pre-processing, a large amount of meat remains, and a yield is poor. Depending on the fish species, the fish meat collecting yield is generally said to be 60% to 80% for dressed fish and 25% to 40% for raw fish.

On the other hand, various contrivances have been made in order to increase the meat collecting yield, and bone and meat separators that separate bone and meat by crushing and extrusion have also been developed (see, for example, Patent Literature 3.).

In addition, as a conventional technique for introducing an enzyme into a food material, a method for producing a food material in which an enzyme is introduced into tissue of a vegetable food material which is softened while maintaining an original shape of the food material (see, for example, Patent Literature 4), a method for producing a soft vegetable food product in which after the salinity or the like of a seasoning liquid is adjusted, a vegetable food which has been frozen and thawed is immersed in an enzyme solution and depressurized to introduce the enzyme into tissue, and then seasoned and heat-sterilized by pressure without losing a shape thereof (see, for example, Patent Literature 5), and the like are known.

### CITATION LIST

### Patent Literature

Patent Literature 1: JP 49-072785 U1

Patent Literature 2: JP 50-089991 U1

Patent Literature 3: JP 2019-515647 A

Patent Literature 4: Japanese Patent No. 3686912

Patent Literature 5: JP 2006-223122 A

### Non Patent Literature

Non Patent Literature 1: Willett, W. et al, Food in the Anthropocene: the EAT-Lancet Commission on Healthy Diets from Sustainable Food Systems, Lancet 393, 447-492 (2019)

Non Patent Literature 2: Golden, C. et al, Aquatic foods to nourish nations, Nature 598, 315-320 (2021)

Non Patent Literature 3: FAO: The State of World Fisheries and Aquaculture. 2020

Non Patent Literature 4: Kyosuke Nishitani et al.: Research on Freezing and Application of Surimi (fifth report),

Regarding a production method of a frozen surimi as a raw material for pastry products. Journal of Hokkaido Fisheries Experimental Station. 18(4), 14-27(1961)

### SUMMARY OF INVENTION

### Technical Problem

However, no fish meat collecting machines can collect the above-described skeletal muscles such as streaks and tendons and meat connected to fish skin and bones, and thus utilization of the meat residue is a major problem.

For example, even when the conventional techniques relating to softening of food described in Patent Literature 4 and 5 are used, how to collect muscle tissue from a fish bone is still a major problem.

Therefore, in order to solve such a problem, an object of the present invention is to provide a production method for animal-derived protein with which fish protein separated and collected from bones can be efficiently produced.

### Solution to Problem

A production method according to claim 1 of the present invention is a production method for producing animal-derived protein, the method including: an enzyme addition step of finely cutting a raw material composed of at least one of fish and processing residue thereof and adding an enzyme solution; a depressurization step of performing a depressurization/normal-pressurization operation once or more in which the raw material treated in the enzyme addition step is vacuum-depressurized, moisture in a raw material is vaporized, and then pressure is returned to normal pressure; an enzymatic decomposition step of leaving the raw material for a certain period of time at an optimum temperature and an optimum pH for an enzyme reaction of the enzyme solution; an enzyme deactivation step of raising a temperature to 90° C. to 95° C. to deactivate the enzyme in the enzyme solution at a high temperature; and a bone and meat separation step of separating and collecting protein of the raw material from bones by a bone and meat separation device after deactivating the enzyme in the enzyme deactivation step.

### Advantageous Effects of Invention

According to the present invention, fish protein separated and collected from bones can be efficiently produced. As a result, in food production, energy can be saved as compared with the conventional production method, water can be saved significantly, and a load on the environment can be reduced, and muscle tissue such as fish can be separated from bones without waste with high work efficiency. In addition, a material obtained by separating meat from bones can be used as a raw material of fish meat protein, fish meat peptide, fish oil, and fish bone calcium when further subjected to a solid-liquid separation step and an oil-water separation step, which thus has great industrial significance in terms of allowing the utilization of unused or low used fish and production processing residue, reduction in food waste, and creation of a new edible protein source.

### BRIEF DESCRIPTION OF DRAWINGS

FIG. 1 is a flowchart of a representative example of a bone and meat separation process according to the present invention.

FIG. 2A is an optical microscope photograph showing fish meat of yellowfin tuna immediately after freezing.

FIG. 2B is an optical microscope photograph showing fish meat of yellowfin tuna after being frozen and stored at −18° C. for 50 days.

FIG. 3A is an electron micrograph showing a structure of muscle fiber tissue of a flatfish immediately before a depressurization step.

FIG. 3B is an electron micrograph showing a structure of muscle fiber tissue of a flatfish immediately after a depressurization step.

FIG. 4A is an electron micrograph showing a cross-sectional structure of muscle tissue of a flatfish immediately before a depressurization step.

FIG. 4B is an electron micrograph showing a cross-sectional structure of muscle tissue of a flatfish immediately after a depressurization step.

FIG. 5 is a diagram for illustrating a conventional technique of physically separating fish meat from bones and skin using a mesh drum type fish meat collecting machine.

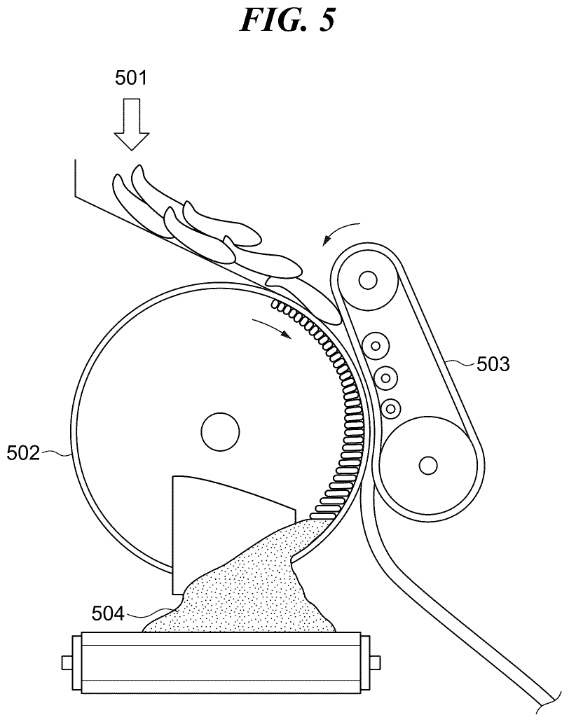

### DESCRIPTION OF EMBODIMENTS

Hereinafter, embodiments of the present invention will be described in detail with reference to the accompanying drawings. Note that the following embodiments do not limit the present invention according to the claims, and all combinations of features described in the present embodiments are not necessarily essential to the solution of the present invention.

In order to solve the above-described problems of the conventional technique, an object of the present invention is to provide a production method with which fish protein separated and collected from bones can be efficiently produced by performing a process highly effective in separating bones and meat.

In order to achieve the above object, as a result of intensive research, the inventor has arrived at the following technical method. A principle of the method includes four operations: (1) a slow freezing operation, (2) a vacuum-depressurizing operation, (3) an in-out simultaneous decomposition operation of enzyme, and (4) a bone and meat separation operation.

In a basic procedure of the specific operation, first, a slow freezing operation is performed in which a raw material including at least one of raw or heat-modified fish and processing residue thereof is frozen by passing through a slow freezing temperature zone of about −7° C. to −20° C. (freezing step). Thereafter, the frozen raw material is finely cut, an enzyme solution is then added, and the mixture is thawed while being stirred (enzyme addition step). If possible, the thawed raw material is heated to a predetermined temperature (the optimum temperature for an enzyme reaction of the added enzyme solution) in order to reduce a load on a vacuum pump in a subsequent vacuum-depressurizing operation. The stirring may be performed during the vacuum-depressurizing operation which will be described later. In addition, the heating may be performed during the vacuum-depressurizing operation or during the in-out simultaneous decomposition operation of the enzyme, which will be described later.

Next, the vacuum-depressurizing operation of reducing a pressure with a vacuum pump is performed while the added enzyme solution is still remained. Thereafter, contents are expanded and then the pressure is returned to normal (atmospheric) pressure. This repetition of the depressurization/normal-pressurization is performed again or several times as necessary, and then the pressure is returned to normal pressure (depressurization step).

Next, the in-out simultaneous decomposition operation of the enzyme that allows the enzymatic reaction to proceed at a predetermined temperature is performed (enzymatic decomposition step). When a target degree of decomposition is reached, the temperature is raised, and the enzyme in a treated product is deactivated by a heating treatment or the like (enzyme deactivation step). By deactivation by heating, decomposition stops and bacteria are also killed. Furthermore, collagen, such as fish skin and connective tissue, which cannot be decomposed, is thermally denatured to form gelatin, which makes it easy to collect. It is noted that formulation of the enzyme preparation, each procedure, and a temperature control need to be changed according to raw materials and equipment used.

Thereafter, the product is fed to a bone and meat separation device, a bone and meat separation operation for separating meat from bones is performed (bone and meat separation step), and then a product producing step of producing a product is performed through a subsequent dehydration and purification step. In a case where a small amount of raw material is used or the like, the meat may be separated from the bones by a sieve or a strainer instead of the bone and meat separation device.

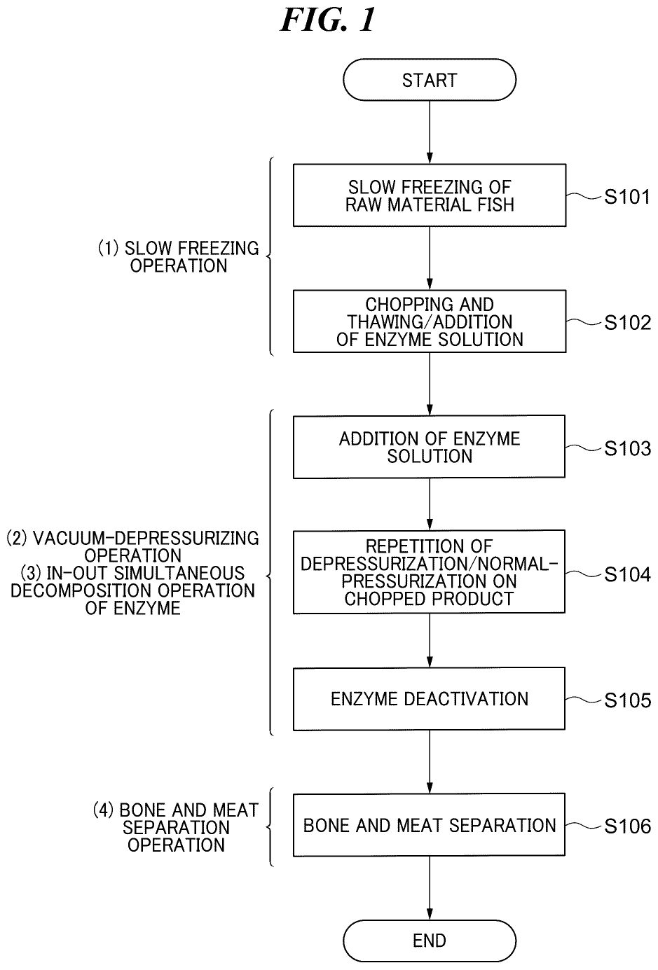

Hereinafter, a representative example of the bone and meat separation process including the above four operations will be described with reference to a flowchart of FIG. 1. Note that the slow freezing operation included in the representative example illustrated in FIG. 1 is not an essential operation in the present invention as in

Example 4 which will be described later. That is, the raw material may be finely cut as raw, then the enzyme solution may be added and stirred, and then the vacuum-depressurizing operation may be performed. However, loosening of the tissue caused by the slow freezing operation accelerate muscle tissue destruction and enzyme introduction speed due to volume expansion and contraction during the depressurization step, and thus, it is more preferable to add the operation. In addition, it is conceivable to perform a pressurizing operation instead of the vacuum depressurizing operation, but the vacuum-depressurizing operation is preferable in that the enzyme can be efficiently introduced into the fish meat. By these operations, the enzyme penetrates throughout the tissue, and a time difference in the enzyme reaction between a surface and an inside of the fish meat can be eliminated. Further, in the flowchart of FIG. 1, the heating is performed before the “(2) vacuum-depressurizing operation” to reduce a load on a vacuum machine, but the “(2) vacuum-depressurizing operation” may be performed before the heating.

First, steps S101 and S102 are performed for the slow freezing operation. First, in step S101, a raw material fish is slowly frozen. As a result, ice crystals are formed and grown inside a raw material fish, which loosens binding of the muscle tissue inside the raw material fish. Thereafter, the process proceeds to step S102, and the raw material fish after the slow freezing is chopped and thawed to obtain a chopped product.

Next, steps S103 to S105 are performed for the vacuum-depressurizing operation and the in-out simultaneous decomposition operation of an enzyme. First, in step S103, the enzyme solution is added to the chopped product obtained in step S102. By cutting the raw material, a surface area increases, a thawing speed increases, and the enzyme solution to be introduced also easily enters the raw material. Next, the process proceeds to step S104, the chopped product after the addition of the enzyme solution is placed in a vacuum depressurization apparatus, and depressurization/normal-pressurization of the chopped product at a predetermined temperature are repeated. At the time of depressurization in step S104, when the moisture inside the muscle in the chopped product is vaporized (boiled) and expanded and when the pressure is returned to normal pressure, the vaporized moisture is liquefied and contracted. In the process of repeated expansion and contraction, the muscle tissue inside the chopped product is destroyed by a force of physically stretching the muscle tissue. Furthermore, at the time of returning to normal pressure to contract the moisture, the enzyme solution previously added to the chopped product in step S103 is replaced with the water in the tissue inside the chopped product, fills voids of the muscle tissue, and penetrates throughout. Here, the predetermined temperature is a temperature set according to properties of the enzyme added, and is a temperature at which the enzyme that has permeated the muscle tissue in step S104 has an activity capable of decomposing hard protein such as collagen in a bone meat joint or myofibrillar protein, simultaneously inside and outside the muscle tissue. Thereafter, in step S105, the temperature of the chopped product after the addition of the enzyme solution after the treatment in step S104 is raised, and the enzyme added is deactivated.

Finally, step S106 is performed for the bone and meat separation operation. In step S106, the meat is separated from bones by the bone and meat separation device, and this process ends.

As described above, in the present invention, muscle tissues such as fish are efficiently separated and collected from bones by the bone and meat separation process in FIG. 1, and animal-derived protein is produced.

Details of each of steps S101 to S106 will be described below.

### Step S101: Slow Freezing of Raw Material Fish

This step is a step of freezing and storing the raw material fish at −7° C. to −20° C. The raw material fish is not particularly limited, but a single fish species such as small sardine, Anchovy, horse mackerel, mackerel, and blue whitening, and unused or low used fish such as small fish or exterminated fish are used. In addition, fish iliac bones and meat residue produced by processing of minced fish or end meats, medium bones, and head fins which are produced by canning, fillets, or fish slicing are also used, and fish that have been frozen and freezer burnt by excessive refrigeration for a long period of time or heat-denatured fish can also be used as raw materials.

When water freezes, water molecules are aligned by hydrogen bonds and become crystalline. The volume thereof is 1.1 times larger than that of a liquid state. In the slow freezing/thawing operation, ice crystals are formed and grown inside the cells and the muscle tissue in the raw material, so that the volume expands, which destroys the cells and the muscle tissue. That is, in the slow freezing/thawing operation, the ice crystals grow and become large, and when entering the so-called “porous” state, the cells and muscle tissues in the raw material are destroyed, and the bonding with the bone is also loosened.

Usually, the size and number of ice crystals generated at the time of freezing depend on a temperature at the time of crystallization. That is, a rate at which ice crystal seeds are generated (ice nucleation rate) and a rate at which the seeds grow (crystal growth rate) depend on a temperature at which ice crystals start to be generated in food. When ice crystals are generated at a low temperature, a large number of ice nuclei are generated, but a growth rate thereof is slow, so that small ice crystals are formed. On the other hand, when ice crystals are generated at a high temperature, a small number of ice nuclei are generated and the growth rate is high, so that large ice crystals are formed.

During the frozen storage, some of the ice crystals melt when the environmental temperature rises. In this case, relatively small ice crystals disappear and become liquid water, but large ice crystals remain. Next, when the temperature drops, remaining ice crystals grow according to the phase equilibrium. When the melting and the crystal growth as described above are repeated, small ice crystals gradually disappear, and large ice crystals become larger and larger. This slow freezing step uses these principles and destroys muscle tissue with a force of ice crystal growth during frozen storage.

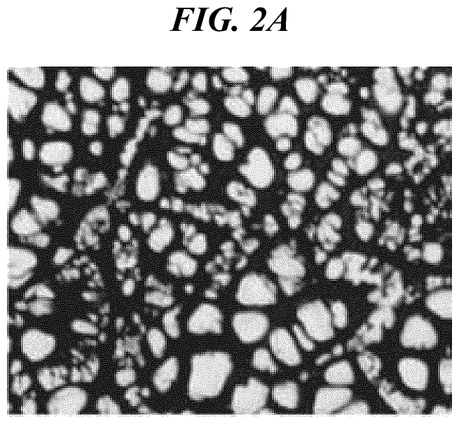

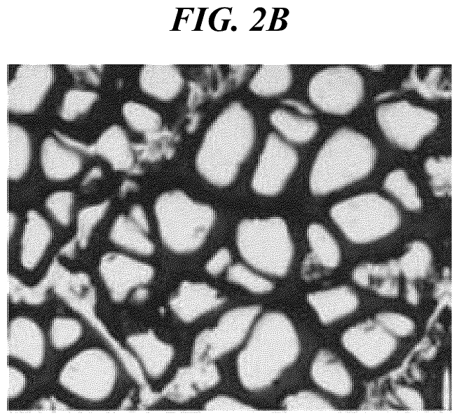

FIGS. 2A and 2B show optical micrographs of fish meat of yellowfin tuna taken at a magnification of 200. FIG. 2A shows fish meat of yellowfin tuna immediately after freezing, and FIG. 2B shows fish meat of yellowfin tuna after being frozen and stored at −18° C. for 50 days. These photographs were taken with a BX 50 system optical microscope (Olympus Corporation) at a magnification of 200. It can be seen that as the storage time increases, ice crystals grow large, the muscle tissue is loosened, and so-called “porous” state are formed.

### Step S102: Chopping and Thawing

This step is a step of appropriately cutting the frozen raw material taken out of the freezer or fresh raw material. By cutting the raw material, a surface area increases, a thawing speed increases, and the enzyme solution to be introduced in step S103 also easily enters the raw material. Here, a frozen cutter is used, but a silent cutter or a freezer cutting machine may be used. Using a vacuum cutter having both cutting and vacuum depressurization functions is even better.

### Step S103: Addition of Enzyme Solution

This step is a step of charging the enzyme solution into the raw material (chopped product) finely cut in step S102. The finely cut raw material is charged into a depressurized decomposition tank (as it is, in the case that the vacuum cutter has been used), and a proteolytic enzyme (protease) solution or fruit pulps and juices having a predetermined concentration is charged thereto and stirred. Here, actinidain, which is a kind of protease, is used, but other plant-based enzyme preparations (such as papain, bromelain, ficin, and ginger protease), animal-based enzyme preparations (such as pepsin, trypsin, and chymotrypsin), microorganism-derived proteolytic enzyme preparations (such as sumizyme), or plants and extracts thereof (such as kiwi fruit, maitake mushrooms, papaya, and pineapple) may be used alone or in combination. With respect to the raw material, an amount of the enzyme preparation used is 0.01% by weight to 1.0% by weight, preferably 0.03% by weight to 0.5% by weight, and more preferably 0.05% by weight to 0.10% by weight, and an amount of the fruit pulp and juice used is 0.5% by weight to 10.0% by weight, preferably 1.0% by weight to 5.0% by weight, and more preferably 1.5% by weight to 3.0% by weight, and a pH is adjusted to a pH range for an optimum reaction of the enzyme, for example, pH 6.5, with sodium bicarbonate or acetic acid, and then heating is performed to a predetermined temperature (optimum temperature for the enzyme reaction of the enzyme solution) in order to reduce the load on the vacuum pump in a next step. For example, heating is performed so as to be 30° C. to 75° C., preferably 40° C. to 65° C., and more preferably 45° C. to 60° C. However, the heating timing may be during the subsequent vacuum-depressurizing operation or during the in-out simultaneous decomposition operation of an enzyme.

### Step S104: Repetition of Depressurization/Normal-Pressurization on Chopped Product

This step includes a depressurization step and an enzymatic decomposition step. The depressurization step is a step of performing a depressurization/normal-pressurization operation once or more in which the chopped product is vacuum depressurized and then the pressure is returned to normal pressure. After the inside of the fish meat and a bone meat connecting portion are expanded by vaporization of moisture by vacuum depressurization, the pressure is returned to normal pressure, so that the inside of the fish meat and the bone meat connecting portion are contracted. In the process of repeating this expansion and contraction, the muscle tissue is stretched and destroyed. In addition, in the depressurization step, when the chopped product is returned from the depressurized state to normal pressure, the enzyme solution added in advance is replaced with water in the tissue, and the voids of the muscle tissue of the chopped product are filled with the enzyme solution, so that the enzyme solution permeates throughout. In the enzymatic decomposition step, in this state, the raw material is placed under the optimum temperature and the optimum pH conditions for the enzyme reaction of the enzyme solution, and the muscle tissue is simultaneously decomposed inside and outside.

### Depressurization Step

In the depressurization step, the vacuum cutter after the enzyme is put in or the vacuum pump of a heated raw material decomposition tank is operated, moisture in the raw material is vaporized, and the depressurized state is maintained for 10 seconds at the time when the contents are expanded, and the muscle tissue is destroyed by the expansion force. Thereafter, the raw material returns to normal pressure. If necessary, in the depressurization step, this depressurization/normal-pressurization operation is repeated once or several times. As a result, when the chopped product returns to normal pressure, the enzyme solution added in advance penetrates throughout the voids of the raw material tissue at once.

According to the vapor pressure curve of water, regarding a boiling point of water, 101.325 kPa at 100° C., 19.865 kPa at 60° C., 0.611 kPa at 0° C., and 0.107 kPa at −20° C. are satisfied. In a case of vaporizing the moisture in the muscle tissue of the chopped product in the depressurization step, a requirement of the degree of vacuum is less at a high temperature than at a low temperature, and the load on the vacuum pump is reduced. For example, at 60° C., which is the optimum temperature for an enzyme reaction of a plant-based proteolytic enzyme solution, water vaporizes when reaching about 19.865 kPa or less. Therefore, it is desirable that the depressurization step is performed at a predetermined temperature (optimum temperature for the enzyme reaction of the enzyme solution).

When the moisture in the muscle tissue is vaporized by depressurizing the raw material at a predetermined temperature, a volume V of gas is proportional to an absolute temperature T and inversely proportional to a pressure P according to the Boyle-Charles' law. When the number of moles of gas is n and a gas constant is R, a relationship of the gas state equation PV=nRT is established. For example, when the predetermined temperature is 60° C.:
19.865 kPa×V=1 mol×8.31×(273+60), and V=139.3 L are satisfied. Since 18 g of 1 mol of water=0.018 L, the volume of water expands 139.3/0.018=7739 times. That is, the volume of water expands 7000 times or more when performing depressurization at 60° C. In the similar calculation, the volume of water expands 12000 times or more at 50° C. and 19000 times or more at 40° C. By repeating the expansion and contraction, the loosened muscle tissue at the time of slow freezing is further physically torn and destroyed, the enzyme solution easily permeates at the time of contraction, and the bone and meat separation step is easily performed.

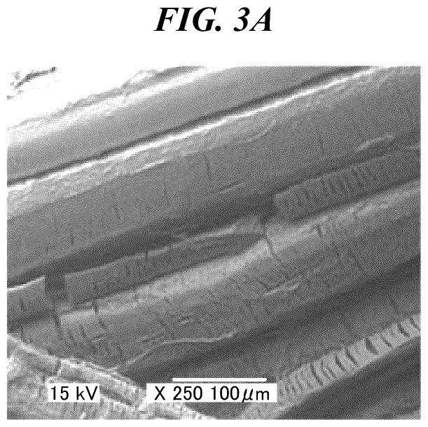

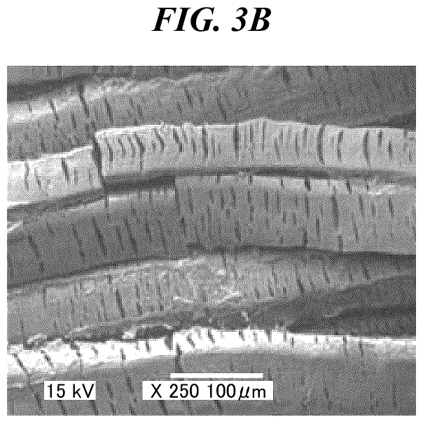

FIG. 3A is an electron micrograph showing a structure of muscle fiber tissue of a flatfish immediately before the depressurization step, and FIG. 3B is an electron micrograph showing a structure of muscle fiber tissue of a flatfish immediately after the depressurization step. These electron micrographs were taken using a JSM-5600 LV scanning electron microscope (JEOL Ltd.) in a low vacuum mode at 15 kV and a magnification of 250. After moisture vaporization volume expansion by depressurization, it can be seen that the muscle fiber tissue is shredded and destroyed.

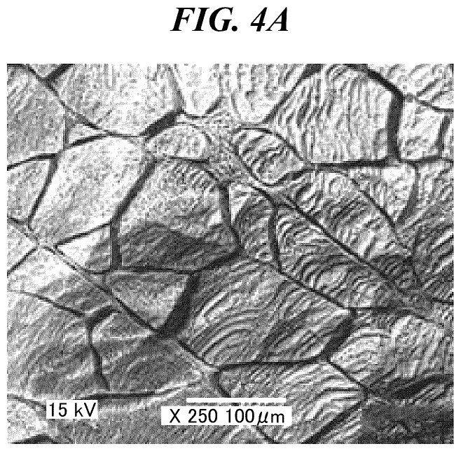

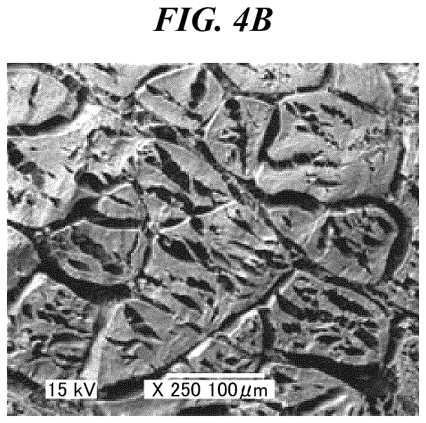

FIG. 4A is an electron micrograph showing a cross-sectional structure of muscle tissue of a flatfish immediately before the depressurization step, and FIG. 4B is an electron micrograph showing a cross-sectional structure of muscle tissue of a flatfish immediately after the depressurization step. These electron micrographs were taken using a JSM-5600 LV scanning electron microscope (JEOL Ltd.) in a low vacuum mode at 15 kV and a magnification of 250. After moisture vaporization volume expansion by depressurization, it can be seen that the cross-section of the muscle fiber is torn and destroyed.

### Enzymatic Decomposition Step

In the enzymatic decomposition step, in a state where the pressure is returned to normal pressure after the depressurization step, the raw material is kept maintaining a predetermined temperature, in a raw material decomposition device such as a heating kneader, a heating pot, or a Joule heater, for a certain period of time, specifically, for 10 minutes to 120 minutes, preferably 15 minutes to 60 minutes, and more preferably 20 minutes to 40 minutes, so that an enzymatic decomposition cleavage reaction of connective tissue and muscle protein is performed. Note that the certain period of time may be a period of time until a predetermined target degree of decomposition is reached.

### Step S105: Enzyme Deactivation

In this step, a temperature of the raw material decomposition tank after completion of the enzymatic decomposition step is raised while performing stirring, and the raw material decomposition tank is left at 90° C. to 95° C. for 60 minutes to deactivate the enzyme in the enzyme solution. In this case, a part of the collagen that cannot be completely decomposed is softened by gelatinization, the breaking strength is reduced, and collecting becomes easier.

### Step S106: Bone and Meat Separation

This step is a bone and meat separation step of removing the bone from the raw material after the enzymatic decomposition. Here, the bone and meat separator is used, but various kinds of meat collectors, strainers, refiners, sieving-type squeezers, and the like may be used.

Hereinafter, the principle and embodiments of the present invention will be described with reference to Examples. However, the following examples merely describe the method of the present invention and the central idea thereof, and those skilled in the art can change specific embodiments and application ranges on the basis of the idea of the present invention. Therefore, the content of the present specification does not limit the present invention.

### Example 1

Meat residue (bones, skin, fins, streaks, and the like) of White croaker (Scientific name: Pennahia argentata) at the time of producing raw minced fish is frozen in a freezer at −18° C. for 1 month, then taken out, and chopped with a food cutter, then 3% of green kiwifruit juice is added to the raw material to adjust pH to 6.5, and after stirring, a heat-resistant and pressure-resistant bag is filled with the raw material and depressurized by a tabletop vacuum packaging machine, and when contents are in an expanded state, the vacuum is stopped, the depressurized state is maintained for 10 seconds, then when the pressure is returned to normal pressure, the depressurization operation is performed again to seal the heat-resistant and pressure-resistant bag filled with the raw material. The sealed heat-resistant and pressure-resistant bag was placed in a thermostatic water bath at 60° C., and subjected to an enzymatic decomposition reaction while maintaining the temperature at 60° C., and after 20 minutes elapsed, the temperature was raised, and the bag was left at 90° C. for 60 minutes to deactivate the enzyme in the enzyme solution. Thereafter, the muscle tissue decomposition product was separated from the bones by a sieve and was subjected to a next product production step.

### Example 2

Middle bones after fillet processing of cultivated Basa fish (Scientific name: Pangasius bocourti) are frozen in a freezer at −18° C. for 6 months, then taken out, charged into a vacuum stephan cutter, and chopped, and then 5% of the green kiwi fruit pulps are added to the raw material to adjust pH to 6.3, a vacuum pump is pulled while stirring to perform depressurization, and when contents are in an expanded state, the vacuum is stopped, the depressurized state is maintained for 10 seconds, then the pressure is returned to normal pressure. Thereafter, the raw material was put in a tabletop Joule heating type bean curd production device, heated by energization, and subjected to an enzymatic decomposition reaction while maintaining the temperature at 60° C., and after 20 minutes elapsed, the temperature was raised, and then the device was left at 95° C. for 60 minutes to deactivate the enzyme in the enzyme solution. Thereafter, the muscle tissue decomposition product was separated from the bones by a sieve and was subjected to a next product production step.

### Example 3

A block (55×37×5 cm) of frozen Japanese anchovy (Scientific name: Engraulis japonica) is frozen in a freezer at −18° C. for 12 months, then taken out, and put into a vacuum ball cutter. Thereafter, while chopping the raw material with a vacuum ball cutter, a papain solution is charged into the vacuum ball cutter so that a final concentration is 0.05% to adjust pH to 7.0 using a sodium bicarbonate solution. Thereafter, a depressurization/normal-pressurization operation in which the vacuum pump is operated, and when the raw material expands due to moisture vaporization inside and the contents are in an expanded state, the vacuum is stopped, the depressurized state is maintained for 10 seconds, then the pressure is returned to normal pressure is performed. The same depressurization/normal-pressurization operation is performed again. Thereafter, the raw material was taken out, put into a heating kneader and heated, and subjected to an enzymatic decomposition reaction while maintaining the temperature at 60° C., and after 20 minutes elapsed, the temperature was raised, and then the device was left at 95° C. for 60 minutes to deactivate the enzyme in the enzyme solution. Thereafter, the muscle tissue decomposition product was separated from the bones by a strainer and was subjected to a next product production step.

### Example 4

Meat residue (bones, skin, fins, streaks, and the like) of Alaska pollock (Scientific name: Gadus chalcogrammus) at the time of producing minced fish is obtained by ice-cooling, charged into a silent cutter as it is in the fresh state, chopped, and then transferred to a vacuum-depressurizing decomposition tank, an actinidain solution is charged so as to have a final concentration of 0.1%, and heated while being stirred to adjust pH to 6.5 using a sodium bicarbonate solution and acetic acid, and then the heating is stopped at the time when the temperature reaches 60° C. Thereafter, a depressurization/normal-pressurization operation in which the vacuum pump is operated while maintaining a temperature at 60° C., and when the raw material expands due to moisture vaporization inside at around 18 kPa and the contents are in an expanded state, the vacuum is stopped, the depressurized state is maintained for 10 seconds, and then the pressure is returned to normal pressure is performed. The same depressurization/normal-pressurization operation was performed again, then an enzymatic decomposition reaction was performed while maintaining the temperature at 60° C., and after 20 minutes elapsed, the temperature was raised, and the tank was left at 90° C. for 60 minutes to deactivate the enzyme in the enzyme solution. Thereafter, the muscle tissue decomposition product was separated from the bones by a bone and meat separator and was subjected to a next product production step.

### Example 5

Heads, scales, backbones, fins, and the like left over from fillet production of Pacific cod (Scientific name: Gadus macrocephalus) are placed in a freezing pan, and frozen with a freezer at-18° C. for 6 months, then taken out, and put into a vacuum ball cutter, a bromelain solution is charged thereto so as to have a final concentration of 0.1% while being chopped to adjust pH to 6.5 using a sodium bicarbonate solution and acetic acid. Thereafter, a depressurization/normal-pressurization operation in which the vacuum pump is operated, and when the raw material expands due to moisture vaporization inside and the contents are in an expanded state, the vacuum is stopped, the depressurized state is maintained for 10 seconds, and then the pressure is returned to normal pressure is performed. The same depressurization/normal- pressurization operation was performed again, and then the raw materials were taken out, put into a continuous Joule heating line, and subjected to an enzymatic decomposition reaction while maintaining the temperature at 60° C. by energization heating, and after 20 minutes of heat retention, the temperature was raised, and the line was left at 95° C. for 60 minutes to deactivate the enzyme in the enzyme solution. Thereafter, the muscle tissue decomposition product was separated from the bones by a strainer and was subjected to a next product production step.

### Example 6

A frozen product of backbones, skin, fins, and the like left over sashimi production of Yellowfin tuna (Scientific name: Thunnus albacares) is frozen in a freezer at-18° C. for 6 months, then taken out, charged into frozen cutter, chopped, and then transferred to a vacuum-depressurizing decomposition tank, an actinidain solution is charged so as to have a final concentration of 0.1%, and heated while being stirred to adjust pH to 6.5 using a sodium bicarbonate solution and acetic acid, and then the heating is stopped at the time when the temperature reaches 60° C. Thereafter, a depressurization/normal-pressurization operation in which the vacuum pump is operated, while maintaining a temperature at 60° C., and when the raw material expands due to moisture vaporization inside at around 18 kPa and the contents are in an expanded state, the vacuum is stopped, the depressurized state is maintained for 10 seconds, and then the pressure is returned to normal pressure is performed. The same depressurization/normal-pressurization operation was performed again, then an enzymatic decomposition reaction was performed while maintaining the temperature at 60° C., and after 20 minutes elapsed, the temperature was raised, and the tank was left at 90° C. for 60 minutes to deactivate the enzyme in the enzyme solution. Thereafter, the muscle tissue decomposition product was separated from the bones by a bone and meat separator and was subjected to a next product production step.

### Example 7

Exterminated Black bass (Scientific name: Micropterus) is washed, then arranged in a freezing pan, frozen in a freezer at −18° C. for 1 month, then taken out, charged into a frozen cutter, chopped, and then transferred to a vacuum-depressurizing decomposition tank, a green kiwi fruit extract is charged so as to have a final concentration of 1%, and heated while being stirred to adjust pH to 6.5 using a sodium bicarbonate solution and acetic acid, and then the heating is stopped at the time when the temperature reaches 60° C. Thereafter, a depressurization/normal-pressurization operation in which the vacuum pump is operated, while maintaining a temperature at 60° C., and when the raw material expands due to moisture vaporization inside at around 18 kPa and the contents are in an expanded state, the vacuum is stopped, the depressurized state is maintained for 10 seconds, and then the pressure is returned to normal pressure is performed. The same depressurization/normal-pressurization operation was performed again, and then an enzymatic decomposition reaction was performed while maintaining the temperature at 60° C., and after 20 minutes elapsed, the temperature was raised, and the tank was left at 90° C. for 60 minutes to deactivate the enzyme in the enzyme solution by the leaving. Thereafter, the muscle tissue decomposition product was separated from the bones by a bone and meat separator and was subjected to a next product production step.

### Example 8

A frozen block of Japanese barracuda (Scientific name: Sphyraena japonica) which is left in a freezer for 3 years and 4 months, has denatured protein due to freezer burn, and is not suitable as a normal edible raw material is taken out, charged into a frozen cutter, chopped, and then transferred to a vacuum-depressurizing decomposition tank, minced maitake mushrooms is charged so as to have a final concentration of 2%, and heated while being stirred to adjust pH to 7.0 using a sodium bicarbonate solution, and the heating is stopped at the time when the temperature reaches 55° C. Thereafter, a depressurization/normal-pressurization operation in which the vacuum pump is operated, while maintaining a temperature at 55° C., and when the raw material expands due to moisture vaporization inside at around 14 kPa and the contents are in an expanded state, the vacuum is stopped, and the depressurized state is maintained for 10 seconds and then the pressure is returned to normal pressure is performed. The same depressurization/normal-pressurization operation was performed again, then an enzymatic decomposition reaction was performed while maintaining the temperature at 55° C., and after 30 minutes elapsed, the temperature was raised, and the tank was left at 90° C. for 60 minutes to deactivate the enzyme in the enzyme solution. Thereafter, the muscle tissue decomposition product was separated from the bones by a bone and meat separator and was subjected to a next product production step.

### Example 9

Small fish from Thailand is put in a frozen pan, stored in a freezer at −20° C. for 3 months, then charged into a frozen cutter, chopped, and then transferred to a vacuum-depressurizing decomposition tank, an actinidain solution is charged thereto so as to have a final concentration of 0.1%, and heated while being stirred to adjust pH to 6.5 using a sodium bicarbonate solution and acetic acid, and then the heating is stopped when the temperature reaches 60° C. Thereafter, a depressurization/normal-pressurization operation in which the vacuum pump is operated, while maintaining a temperature at 60° C., and when the raw material expands due to moisture vaporization inside at around 18 kPa and the contents are in an expanded state, the vacuum is stopped, the depressurized state is maintained for 10 seconds, and then the pressure is returned to normal pressure is performed. The same depressurization/normal-pressurization operation was performed again, and then an enzymatic decomposition reaction was performed while maintaining the temperature at 60° C., and after 20 minutes elapsed, the temperature was raised, and the tank was left at 90° C. for 60 minutes to deactivate the enzyme in the enzyme solution. Thereafter, the muscle tissue decomposition product was separated from the bones by a strainer and was subjected to a next product production step.

1. A production method for producing animal-derived protein, comprising:
an enzyme addition step of finely cutting a raw material composed of at least one of fish and processing residue thereof and adding an enzyme solution;
a depressurization step of performing a depressurization/normal-pressurization operation once or more in which the raw material treated in the enzyme addition step is vacuum-depressurized, moisture in the raw material is boiled to become a content thereof is in an expanded state,, and then pressure is returned to normal pressure;
an enzymatic decomposition step of leaving the raw material for a certain period of time at an optimum temperature and an optimum pH for an enzyme reaction of the enzyme solution;
an enzyme deactivation step of raising a temperature to 90° C. to 95° C. to deactivate the enzyme in the enzyme solution at a high temperature; and
a bone and meat separation step of separating and collecting a protein of the raw material from bones by a bone and meat separation device after deactivating the enzyme in the enzyme deactivation step.

2. The production method according to claim 1, further comprising:
a freezing step of slowly freezing the raw material to freeze the raw material,
wherein in the enzyme addition step, the raw material is finely cut up in a state where the raw material is frozen, and the enzyme is added after the raw material is thawed.

3. The production method according to claim 2, wherein in the freezing step, the raw material is caused to pass through a slow freezing temperature zone of −7° C. to −20° C.

4. The production method according to claim 1, wherein the enzyme solution contains an enzyme preparation, and an enzyme obtained by combining one or more of fruit pulps and juices including at least one of maitake mushrooms, kiwi fruit, papaya, and pineapple and extracts thereof, an amount of the enzyme preparation used is 0.01% by weight to 1.0% by weight, preferably 0.03% by weight to 0.5% by weight, and more preferably 0.05% by weight to 0.10% by weight, and an amount of the fruit pulps and juices used is 0.5% by weight to 10.0% by weight, preferably 1.0% by weight to 5.0% by weight, and more preferably 1.5% by weight to 3.0% by weight, with respect to the raw material, and pH of the enzyme solution is adjusted to a pH range for an optimum reaction of the enzyme with sodium bicarbonate or acetic acid.

5. The production method according to claim 4, wherein the enzyme preparation includes at least one of a plant-based enzyme preparation, an animal-based enzyme preparation, and a microorganism-derived proteolytic enzyme preparation.

6. The production method according to claim 5, wherein the plant-based enzyme preparation includes at least one of actinidain, papain, bromelain, ficin, and ginger protease.

7. The production method according to claim 5, wherein the animal-based enzyme preparation includes at least one of pepsin, trypsin, and chymotrypsin.

8. The production method according to claim 5, wherein the microorganism-derived proteolytic enzyme preparation is sumizyme.

9. The production method according to claim 1, wherein after the raw material is heated to the optimum temperature, the depressurization/normal-pressurization operation in the depressurization step is performed.

10. The production method according to claim 1, wherein after the enzyme is added to the finely cut raw material in the enzyme addition step, the vacuum-depressurizing is performed while the raw material is stirred in the depressurization step, and the raw material is heated to the optimum temperature in the enzymatic decomposition step.

11. The production method according to claim 1, wherein the optimum temperature is 30° C. to 75° C., preferably 40° C. to 65° C., and more preferably 45° C. to 60° C.

12. The production method according to claim 1, wherein in the bone and meat separation step, protein of the raw material can be separated and collected from bones by a sieve.
